(19) United States
(12) Patent Application Publication
(10) Pub. No.: US 2025/0139698 A1
(43) Pub. Date: May 1, 2025

(54) SYSTEMS AND METHODS FOR DETERMINING PERFORMANCE-BASED PRICING

(71) Applicant: JPMORGAN CHASE BANK, N.A., New York, NY (US)

(72) Inventors: Lakshmi POLAVARAPU, Frisco, TX (US); Sreeramamurty MUTNURI, Frisco, TX (US); Shashanka NARAYAN, Chicago, IL (US); Donald CONTE, Hillsdale, NJ (US); Meghana KANCHARLA, Woodridge, IL (US)

(21) Appl. No.: 18/498,515

(22) Filed: Oct. 31, 2023

(51) Int. Cl. G06Q 40/03

(52) U.S. Cl. CPC G06Q 40/03

(57) ABSTRACT

Systems and methods for determining performance-based pricing are disclosed. A method may include: creating a borrower entry based on borrower loans for a borrower and a borrower rating; polling a plurality of rating agencies for agency borrower ratings; receiving agency borrower ratings from the plurality of rating agencies; determining that one of the agency borrower ratings has changed from a previous agency borrower rating; predicting, using a machine learning engine that is trained with historic agency rating changes, a recommended change to a pricing grid for the borrower based on the change in the agency borrower rating; updating the pricing grid for the borrower based on the recommendation; and providing the updated pricing grid to a loan platform. The loan platform is configured to implement the pricing grid, and the implementation of the pricing grid changes a payment for at least one of the plurality of borrower loans.

### BACKGROUND OF THE INVENTION

### 1. Field of the Invention

Embodiments relate to systems and methods for determining performance-based pricing.

### 2. Description of the Related Art

Commercial lenders often use dynamic pricing that is linked to the borrower's performance. One of the key components for performance-based pricing is tracking external performance ratings of borrowers from Moody, S&P, and Fitch. If rating changes are found, an offline two-touch manual process is used to update the borrower's performance rating.

### SUMMARY OF THE INVENTION

Systems and methods for determining performance-based pricing are disclosed. According to an embodiment, a method may include: (1) creating, by a pricing computer program, a borrower entry based on a plurality of borrower loans for a borrower and a borrower rating; (2) polling, by the pricing computer program, a plurality of rating agencies for agency borrower ratings; (3) receiving, by the pricing computer program, agency borrower ratings from the plurality of rating agencies; (4) determining, by the pricing computer program, that one of the agency borrower ratings has changed from a previous agency borrower rating; (5) predicting, by the pricing computer program and using a machine learning engine that is trained with historic agency rating changes, a recommended change to a pricing grid for the borrower based on the change in the agency borrower rating; (6) updating, by the pricing computer program, the pricing grid for the borrower based on the recommendation; and (7) providing, by the pricing computer program, the updated pricing grid to a loan platform. The loan platform is configured to implement the pricing grid, and the implementation of the pricing grid changes a payment for at least one of the plurality of borrower loans.

In one embodiment, the machine learning engine further returns a confidence in the recommendation.

In one embodiment, the pricing computer program provides the recommendation for human review in response to the confidence being below a threshold.

In one embodiment, the loan platform is further configured to update terms for at least one of the borrower loans.

In one embodiment, the method may also include repeating, by the pricing computer program, the steps of polling the plurality of rating agencies for agency borrower ratings, receiving agency borrower ratings from the plurality of rating agencies, determining that one of the agency borrower ratings has changed from the previous agency borrower rating, predicting the recommended change to the pricing grid for the borrower based on the change in the agency borrower rating, updating the pricing grid for the borrower based on the recommendation, and providing the updated pricing grid to a loan platform. The steps may be repeated during a lifetime of each borrower loan.

According to another embodiment, a system may include: a plurality of rating agencies; a loan system; and an electronic device executing a pricing computer program that is configured to create a borrower entry based on a plurality of borrower loans for a borrower and a borrower rating, to poll the plurality of rating agencies for agency borrower ratings, to receive agency borrower ratings from the plurality of rating agencies, to determine that one of the agency borrower ratings has changed from a previous agency borrower rating, to predict, using a machine learning engine that is trained with historic agency rating changes, a recommended change to a pricing grid for the borrower based on the change in the agency borrower rating, to update the pricing grid for the borrower based on the recommendation, and to provide the updated pricing grid to a loan platform; and the loan platform is configured to implement the pricing grid which changes a payment for at least one of the plurality of borrower loans.

In one embodiment, the machine learning engine is configured to return a confidence in the recommendation.

In one embodiment, the pricing computer program is configured to provide the recommendation for human review in response to the confidence being below a threshold.

In one embodiment, the loan platform is further configured to update terms for at least one of the borrower loans.

In one embodiment, the pricing computer program is further configured to repeat the steps of polling of the plurality of rating agencies for agency borrower ratings, the receiving of agency borrower ratings from the plurality of rating agencies, the determining that one of the agency borrower ratings has changed from the previous agency borrower rating, the predicting of the recommended change to the pricing grid for the borrower based on the change in the agency borrower rating, the updating of the pricing grid for the borrower based on the recommendation, and the providing of the updated pricing grid to a loan platform. The steps may be repeated during a lifetime of each borrower loan.

According to another embodiment, a non-transitory computer readable storage medium may include instructions stored thereon, which when read and executed by one or more computer processors, cause the one or more computer processors to perform steps comprising: creating a borrower entry based on a plurality of borrower loans for a borrower and a borrower rating; polling a plurality of rating agencies for agency borrower ratings; receiving agency borrower ratings from the plurality of rating agencies; determining that one of the agency borrower ratings has changed from a previous agency borrower rating; predicting, using a machine learning engine that is trained with historic agency rating changes, a recommended change to a pricing grid for the borrower based on the change in the agency borrower rating; updating the pricing grid for the borrower based on the recommendation; and providing the updated pricing grid to a loan platform that implements the pricing grid which changes a payment for at least one of the plurality of borrower loans.

In one embodiment, the non-transitory computer readable storage medium may also include instructions stored thereon, which when read and executed by one or more computer processors, cause the one or more computer processors to return a confidence in the recommendation.

In one embodiment, the non-transitory computer readable storage medium may also include instructions stored thereon, which when read and executed by one or more computer processors, cause the one or more computer processors to provide the recommendation for human review in response to the confidence being below a threshold.

In one embodiment, the non-transitory computer readable storage medium may also include instructions stored thereon, which when read and executed by one or more computer processors, cause the one or more computer processors to update terms for at least one of the borrower loans.

In one embodiment, the non-transitory computer readable storage medium may also include instructions stored thereon, which when read and executed by one or more computer processors, cause the one or more computer processors to repeat the steps of polling of the plurality of rating agencies for agency borrower ratings, the receiving of agency borrower ratings from the plurality of rating agencies, the determining that one of the agency borrower ratings has changed from the previous agency borrower rating, the predicting of the recommended change to the pricing grid for the borrower based on the change in the agency borrower rating, the updating of the pricing grid for the borrower based on the recommendation, and the providing of the updated pricing grid to a loan platform. The steps may be repeated during a lifetime of each borrower loan.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for determining performance-based pricing according to an embodiment;

FIG. 2 illustrates a method for determining performance-based pricing according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for determining performance-based pricing.

Embodiments may maintain an inventory of deals, borrowers, and rating types to be monitored. This inventor may check daily against data from rating agencies such as Moody, S&P, and Fitch for any rating changes without any human intervention. Any rating change identified will automatically initiate cases that may result in pricing changes for the borrower.

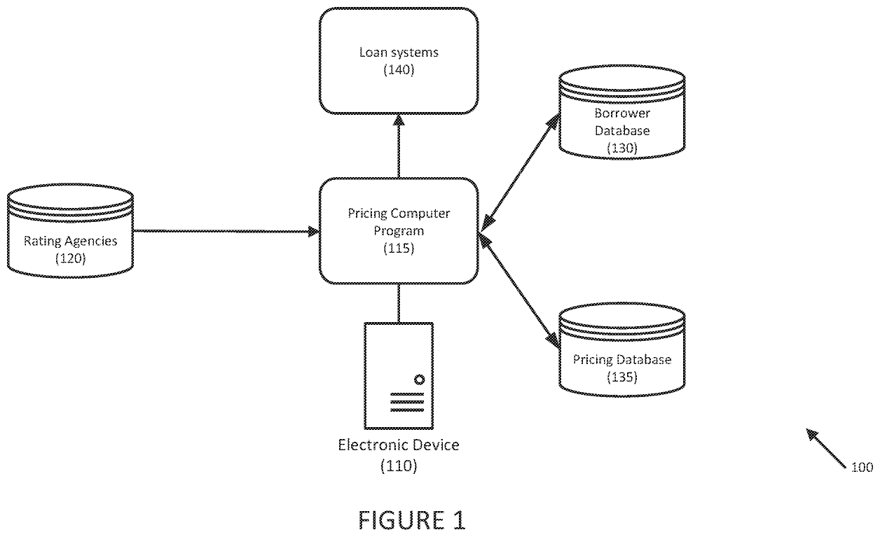

Referring to FIG. 1, a system for determining performance-based pricing is disclosed according to an embodiment. System 100 may include electronic device 110 that may execute pricing computer program 115. Electronic device 110 may include any suitable electronic device, including servers (e.g., physical and/or cloud-based), computers (e.g., workstations, desktops, laptops, tablets, etc.), smart devices (e.g., smart phones, smart watches, etc.), IoT appliances, etc. Pricing computer program 115 may receive current borrower rating data from rating agencies 120, such as Moody, S&P, and Fitch, and may compare the borrower's rating from borrower database 130 to the current borrower rating and may update the pricing in pricing database 135 based on the change in the borrower rating.

Pricing computer program may also provide pricing updates to loan system 140, which may update the pricing of the borrower's loan(s).

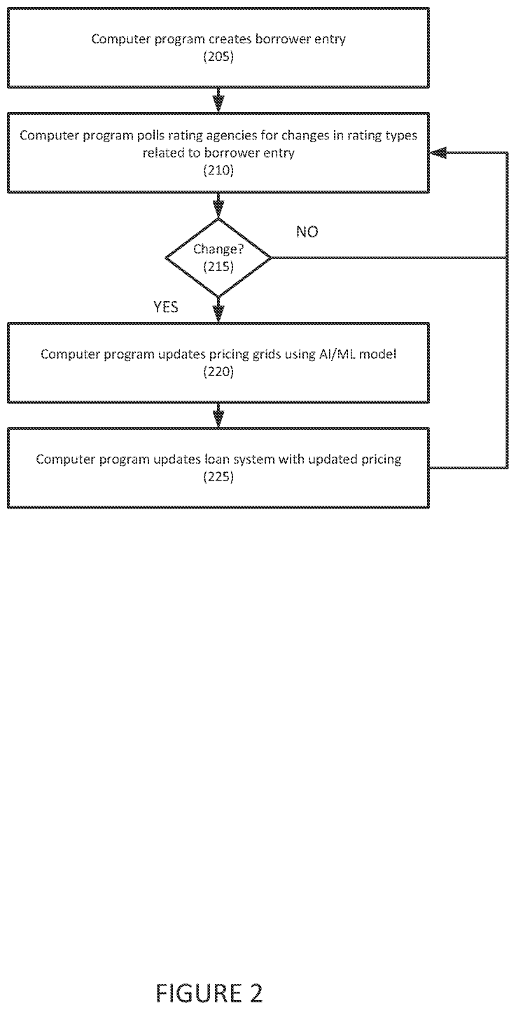

Referring to FIG. 2, a method for determining performance-based pricing is disclosed according to an embodiment.

In step 205, a computer program, such as a pricing computer program, executed on an electronic device may create a borrower entry based loan for a borrower. For example, the pricing computer program may create the borrower entry that identifies the borrower, the borrower's loan(s), and the borrower's rating.

In step 210, the computer program may poll rating agencies for agency borrower ratings related to the borrower entry. In one embodiment, the computer program may provide the rating agencies with a borrower identifier, and may receive agency borrower ratings with the latest update date from each of the rating agencies.

In step 215, the computer program may determine if there is a change in the borrower's rating. For example, the computer program may check, at a borrower level, any of the relevant agency borrower ratings have changed from its previous value. If there is no change, the computer program may disregard that rating agency's borrower rating.

If there is change in the borrower's rating, in step 220, the pricing computer program may use an artificial intelligence/machine learning model to determine the impact of the change on the borrower rating and to update a pricing grid to reflect the change. In one embodiment, the impact may be evaluated and the pricing grid may be updated on a borrower-by-borrower manner. For example, if there is change in an agency rating from any of the rating agencies, AI/ML may be used to access the impact and to predict recommended updates to the pricing grid with an accuracy percentage. If the accuracy percentage for the recommended update is above an acceptable threshold (e.g., over 98%), the pricing grid may be provided to the loan platform for implementation. If the accuracy percentage is not above the acceptable threshold, the recommendation may be prescribed for a user to review.

In one embodiment, a machine learning engine may be trained with historical data, including historical borrower rating changes, pricing grids, impacts, etc. and may predict a recommendation based on the historical data.

In step 225, based on the pricing update, the computer program may update the terms of the borrower's loans based on the recommendation. The update may change a payment associated with at least one of the borrower loans.

The process may be repeated for the life of the borrower's loans.

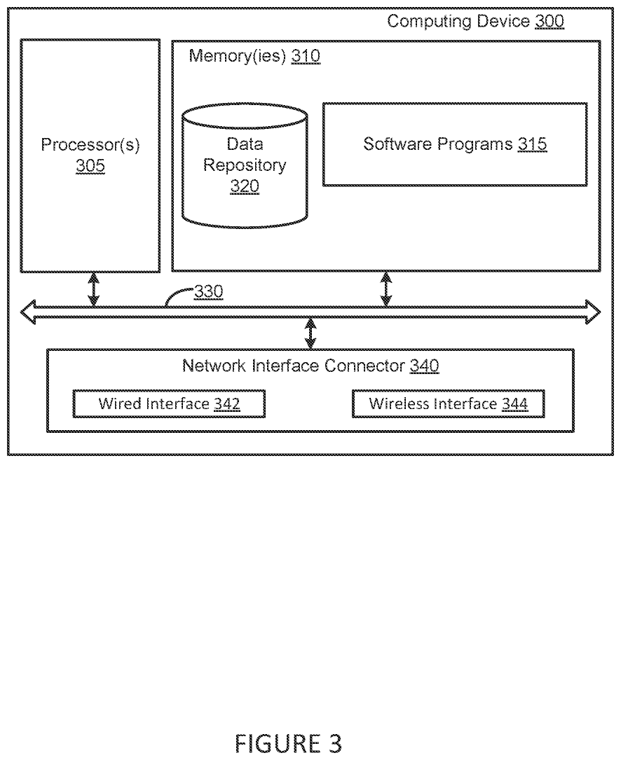

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
creating, by a pricing computer program, a borrower entry based on a plurality of borrower loans for a borrower and a borrower rating;
polling, by the pricing computer program, a plurality of rating agencies for agency borrower ratings;
receiving, by the pricing computer program, agency borrower ratings from the plurality of rating agencies;
determining, by the pricing computer program, that one of the agency borrower ratings has changed from a previous agency borrower rating;
predicting, by the pricing computer program and using a machine learning engine that is trained with historic agency rating changes, a recommended change to a pricing grid for the borrower based on the change in the agency borrower rating;
updating, by the pricing computer program, the pricing grid for the borrower based on the recommendation; and
providing, by the pricing computer program, the updated pricing grid to a loan platform;
wherein the loan platform is configured to implement the pricing grid, and the implementation of the pricing grid changes a payment for at least one of the plurality of borrower loans.

2. The method of claim 1, wherein the machine learning engine further returns a confidence in the recommendation.

3. The method of claim 2, wherein the pricing computer program provides the recommendation for human review in response to the confidence being below a threshold.

4. The method of claim 1, wherein the loan platform is further configured to update terms for at least one of the borrower loans.

5. The method of claim 1, further comprising:
repeating, by the pricing computer program, the steps of polling the plurality of rating agencies for agency borrower ratings, receiving agency borrower ratings from the plurality of rating agencies, determining that one of the agency borrower ratings has changed from the previous agency borrower rating, predicting the recommended change to the pricing grid for the borrower based on the change in the agency borrower rating, updating the pricing grid for the borrower based on the recommendation, and providing the updated pricing grid to a loan platform.

6. The method of claim 5, wherein the steps are repeated during a lifetime of each borrower loan.

7. A system, comprising:
a plurality of rating agencies;
a loan system; and
an electronic device executing a pricing computer program that is configured to create a borrower entry based on a plurality of borrower loans for a borrower and a borrower rating, to poll the plurality of rating agencies for agency borrower ratings, to receive agency borrower ratings from the plurality of rating agencies, to determine that one of the agency borrower ratings has changed from a previous agency borrower rating, to predict, using a machine learning engine that is trained with historic agency rating changes, a recommended change to a pricing grid for the borrower based on the change in the agency borrower rating, to update the pricing grid for the borrower based on the recommendation, and to provide the updated pricing grid to a loan platform; and the loan platform is configured to implement the pricing grid which changes a payment for at least one of the plurality of borrower loans.

8. The system of claim 7, wherein the machine learning engine is configured to return a confidence in the recommendation.

9. The system of claim 8, wherein the pricing computer program is configured to provide the recommendation for human review in response to the confidence being below a threshold.

10. The system of claim 8, wherein the loan platform is further configured to update terms for at least one of the borrower loans.

11. The system of claim 8, wherein the pricing computer program is further configured to repeat the steps of polling of the plurality of rating agencies for agency borrower ratings, the receiving of agency borrower ratings from the plurality of rating agencies, the determining that one of the agency borrower ratings has changed from the previous agency borrower rating, the predicting of the recommended change to the pricing grid for the borrower based on the change in the agency borrower rating, the updating of the pricing grid for the borrower based on the recommendation, and the providing of the updated pricing grid to a loan platform.

12. The system of claim 11, wherein the steps are repeated during a lifetime of each borrower loan.

13. A non-transitory computer readable storage medium, including instructions stored thereon, which when read and executed by one or more computer processors, cause the one or more computer processors to perform steps comprising:
creating a borrower entry based on a plurality of borrower loans for a borrower and a borrower rating;
polling a plurality of rating agencies for agency borrower ratings;
receiving agency borrower ratings from the plurality of rating agencies;
determining that one of the agency borrower ratings has changed from a previous agency borrower rating;
predicting, using a machine learning engine that is trained with historic agency rating changes, a recommended change to a pricing grid for the borrower based on the change in the agency borrower rating;
updating the pricing grid for the borrower based on the recommendation; and
providing the updated pricing grid to a loan platform that implements the pricing grid which changes a payment for at least one of the plurality of borrower loans.

14. The non-transitory computer readable storage medium of claim 13, wherein the machine learning engine returns a confidence in the recommendation.

15. The non-transitory computer readable storage medium of claim 14, further including instructions stored thereon, which when read and executed by one or more computer processors, cause the one or more computer processors to provide the recommendation for human review in response to the confidence being below a threshold.

16. The non-transitory computer readable storage medium of claim 13, further including instructions stored thereon, which when read and executed by one or more computer processors, cause the one or more computer processors to update terms for at least one of the borrower loans.

17. The non-transitory computer readable storage medium of claim 13, further including instructions stored thereon, which when read and executed by one or more computer processors, cause the one or more computer processors to repeat the steps of polling of the plurality of rating agencies for agency borrower ratings, the receiving of agency borrower ratings from the plurality of rating agencies, the determining that one of the agency borrower ratings has changed from the previous agency borrower rating, the predicting of the recommended change to the pricing grid for the borrower based on the change in the agency borrower rating, the updating of the pricing grid for the borrower based on the recommendation, and the providing of the updated pricing grid to a loan platform.

18. The non-transitory computer readable storage medium of claim 17, wherein the steps are repeated during a lifetime of each borrower loan.
